(19) United States
(12) Patent Application Publication
(10) Pub. No.: US 2004/0191720 A1
(43) Pub. Date: Sep. 30, 2004

(54) Vibrating dental device and method

(76) Inventor: Allan Coopersmith, Montreal (CA)

Correspondence Address: DR. ALLAN COOPERSMITH, 5757 Decelles #520, Montreal, QC, H35 2C3, CA

(21) Appl. No.: 10/776,193

(22) Filed: Feb. 12, 2004

Related U.S. Application Data
(60) Provisional application No. 60/446,756, filed on Feb. 13, 2003.

(51) Int. Cl. A61C 9/00; A61C 5/04

(52) U.S. Cl. 433/37; 433/89

(57) ABSTRACT

This invention relates to apparati and methods employed by dentists to mix impression material, to deliver said impression material to the mouth and more specifically around the teeth and gums, to apply said impression material around the teeth and gums in an improved and more accurate manner, and to help withdraw said polymerized (set) impression material from around the teeth and gums. This invention relates to and methods employed by dentists to use vibration to deliver a smooth, consistent impression material below gingival tissues from around the base of a tooth and surrounding structures with minimal entrapment of air, tissue, blood etc. and maximum accuracy around gums or a tooth or teeth such as has been prepared by drilling or other means to receive a dental restoration, such as a crown or inlay, denture, or other prosthesis.

The present application claims the benefit of U.S. provisional Patent Application serial No. 60/446,756 entitled Vibrating Impression Device. The contents of which are incorporated herein by reference.

### FIELD OF THE INVENTION

This invention relates to apparati and methods employed by dentists to mix impression material, to deliver said impression material to the mouth and more specifically around the teeth and gums, to apply said impression material around the teeth and gums in an improved and more accurate manner, and to help withdraw said polymerized (set) impression material from around the teeth and gums. This invention relates to and methods employed by dentists to deliver a smooth, consistent impression material below gingival tissues from around the base of a tooth and surrounding structures with minimal entrapment of air, tissue, blood etc. and maximum accuracy around gums or a tooth or teeth such as has been prepared by drilling or other means to receive a dental restoration, such as a crown or inlay, denture, or other prosthesis.

### BACKGROUND OF THE INVENTION

Vibration has been used in dentistry for many years. It has been used to mix plaster or stone slurries so as to be smooth and homogenous free of entrapped air bubbles. Water and dental stone or plaster is mixed together on a vibrator so as to create this smooth, homogenous slurry with minimal air entrapment. Vibration has also been used when pouring up impressions with plaster or stone in order to make a positive model. The impression tray with set impression material, is placed against a vibrator as the liquid stone or plaster slurry is poured into the impression. The vibration increases the flow characteristics and facilitates the flow of plaster or stone into the most minute corners and crevices making for a more accurate model; it also helps to prevent the entrapment of air causing bubbles. Vibration of the plaster or stone pour into dental impressions helps to eliminate clumping and bubbles, creating smooth, accurate, and precise dental molds or models.

Consequently it may be deduced that vibration would enhance and improve the mixing and dispensing of the impression material and also increase and facilitate the flow of the liquid or semi solid (unset) impression material into the gingival sulcus and around the teeth and gums.

Around each healthy tooth in the mouth of a human is a narrow groove termed a sulcus, which separates the tooth from the surrounding gingival tissue at the surface of the tissue. Certain dental procedures, such as those to create an impression of the tooth and those to create a prosthetic for the tooth, require that the impression material flow freely, evenly, and unimpaired by gingiva (gum tissue), gingival or crevicular fluid, blood, debris saliva etc. Gingival tissue must usually be retracted from the tooth in the area of the sulcus, and sometimes additionally in other areas to allow the flow of impression material below the gingival margin off the prepared teeth as well as around the other teeth and surrounding tissues. While the prior art teaches several means of accomplishing this impression, none are optimal.

Vibration of the impression material will also help provide more effective, smooth and continuous and consistent pressure of the impression material driving it into the gingival sulcus, and around the teeth and gums and helping to prevent entrapment and facilitate the displacement of air or tissue or saliva or blood or debris.

Restorative materials commonly used in dentistry are contained in syringes, carpules, jars, bottles etc. Often these restorative materials are entrapped with air and bubbles, or create air and bubble entrapment as they are dispensed into the dental cavity to be restored. Vibration of containers of dental restorative materials while unset or uncured or un-polymerized, including and not limited to simple and composite resins, cements, acrylics, etc will also help provide easy delivery and dispensing as well as efficient, smooth, compact, consistent filling, restoration, condensation, smoothing, etc., of said dental restorative materials, minimizing air entrapment and bubbles.

### SUMMARY OF THE INVENTION

It is therefore an object of an aspect the present invention to provide an improved apparatus for mixing impression material.

It is therefore an object of an aspect the present invention to provide an improved apparatus for delivering impression material to teeth, gums and surrounding structures.

It is a further object of an aspect of the present invention to provide an improved apparatus for delivering impression material to teeth, natural or prepared, below or apical to the prepared tooth margin.

It is therefore an object of an aspect the present invention to provide an improved apparatus applying impression material to teeth, gums and surrounding structures as well as to teeth, natural or prepared, below or apical to the prepared tooth margin.

It is therefore an object of an aspect the present invention to provide an improved apparatus for increasing the flow of impression material to teeth, gums and surrounding structures as well as to teeth, natural or prepared, below or apical to the prepared tooth margin.

It is therefore an object of an aspect the present invention to provide an improved apparatus for facilitating the flow of impression material to teeth, gums and surrounding structures as well as to teeth, natural or prepared, below or apical to the prepared tooth margin.

It is therefore an object of an aspect the present invention to provide an improved apparatus for increasing the accuracy of impression material to teeth, gums and surrounding structures as well as to teeth, natural or prepared, below or apical to the prepared tooth margin.

It is therefore an object of an aspect the present invention to provide an improved apparatus for reducing the entrapment of air into the impression material as it is applied to teeth, gums and surrounding structures as well as to teeth, natural or prepared, below or apical to the prepared tooth margin.

It is therefore an object of an aspect the present invention to provide an improved apparatus for reducing the entrapment of solids such as tissue, debris, etc., into the impression material as it is applied to teeth, gums and surrounding structures as well as to teeth, natural or prepared, below or apical to the prepared tooth margin.

It is a further object of an aspect of the present invention to provide an improved apparatus for removing the set or polymerized impression material away from the teeth, gums and surrounding structures.

It is a further object of an aspect of the present invention to provide an improved method for delivering impression material to teeth, gums and surrounding structures.

It is a further object of an aspect of the present invention to provide an improved method for delivering impression material to teeth, below or apical to the prepared tooth margin.

It is a further object of an aspect of the present invention to provide an improved method for removing the set or polymerized impression material away from the teeth, gums and surrounding structures.

As embodied and broadly described herein the present invention provides a device which is a vibrating device which imparts a continuous or intermittent or variable vibration to impression materials, and which attaches to the dental or impression material container with a clamp, (spring loaded, screw, mechanical or vice gripped) or elastic or wedge like apparatus and/or which imparts a vibration to the dental or impression material, which attaches to a custom or stock impression tray with a clamp, (spring loaded, screw, mechanical or vice gripped) or elastic or wedge like apparatus delivering dental restorative or impression material to teeth, gums and surrounding structures as well as to teeth, natural or prepared, below or apical to the prepared tooth margin.

As embodied and broadly described herein the present invention provides a device which is a vibrating device which imparts a continuous or intermittent or variable vibration to dental containers and materials and a method of use.

As embodied and broadly described herein the present invention provides a device which is a vibrating device which imparts a continuous or intermittent or variable vibration to dental restorative material, and which attaches to the dental restorative material container with a clamp, (spring loaded, screw, mechanical or vice gripped) or elastic or wedge like apparatus and/or which imparts a vibration to the dental restorative material.

### DESCRIPTION OF THE DRAWINGS

A detailed description of preferred embodiments of the claimed invention is provided herein below, with reference to the following drawings, in which:

FIG. 1 is a top view of a longitudinal cross section of a battery powered vibrating dental device.

FIG. 2. is a side view of a longitudinal cross section of a battery powered vibrating dental device.

FIG. 3 is a top view of the dental impression tray being inserted and attached into the vibrating dental device.

FIG. 4 is the top view of the dental impression tray which has been inserted and attached into the vibrating dental device.

FIG. 5 is the side view of the dental impression tray being inserted into the vibrating dental device.

FIG. 6 is a side view of the impression tray which has been inserted into the vibrating dental device and the operator's finger engaging the vibrating motor switch while seating the impression tray.

FIG. 7 is a side view of the impression tray which is inserted and attached to the vibrating dental device as said tray has been placed over maxillary teeth and gums.

FIG. 8 is a side view of the impression tray which is attached to the vibrating dental device and said tray has been placed over mandibular teeth and gums.

FIG. 9 is a cross sectional view of the receptacle into which the impression tray or dental instrument is inserted and fastened by a circular screw type device.

FIG. 10 is a cross sectional view of the receptacle into which the impression tray or dental instrument is inserted and fastened by the upper and lower plates which are encircled by a heavy duty elastic band.

FIG. 11 is a longitudinal cross section of the vibrating dental device with a spring loaded hinge attachment to hold an impression tray.

FIG. 12 is a top view of a longitudinal cross section of a full mandibular impression tray being inserted into the vibrating dental device.

FIG. 13 is a top view of a longitudinal cross section of the vibrating dental device holding a full maxillary impression tray.

FIG. 14 s a top view of a longitudinal cross section of a cartridge and gun type apparatus commonly used in dentistry to hold and dispense impression material.

FIG. 15 is a side view of a longitudinal cross section of a cartridge and gun type apparatus commonly used in dentistry to hold and dispense impression material with the vibrating dental device attached to said apparatus with an elastic type attachment.

FIG. 16 is a horizontal cross section of a cartridge and gun type apparatus commonly used in dentistry to hold and dispense impression material with the vibrating dental device attached to said apparatus with a friction lock or clip type attachment.

FIG. 17. is a horizontal cross section of the friction locking device which attaches the impression material container to the vibrating dental device.

### DETAILED DESCRIPTION OF THE DRAWINGS

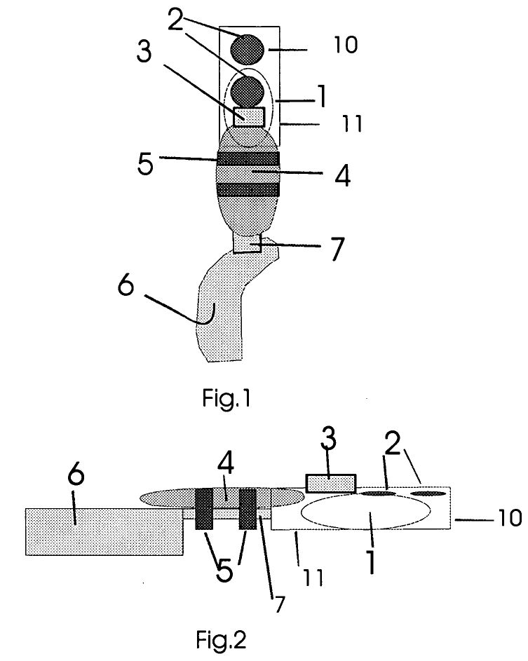

FIG. 1 refers to the top view of a dental vibrating device 10. consisting of a vibrator 1. with a switch 3. and a plate 4.extending from the vibrator housing 11.used to attach to the handle 7.of an impression tray 6.and secure said impression tray handle 7.with a clamp or attaching device 5. The dental vibrating device is powered by two small batteries, 2.

FIG. 2. refers to the side view of the dental vibrating device. As seen in FIG. 1. a plate 4.extends from the vibrator housing 11. to engage the tray handle 7. thereby transmitting vibration to the tray 6. and to the impression material (not shown) contained therein.

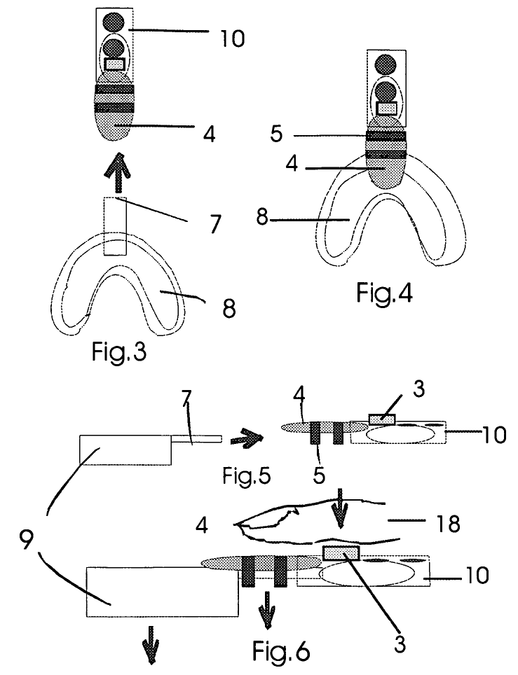

FIG. 3 refers to a top view of the mandibular impression tray 8.fully seated into and attached to the dental vibrating device 10.and secured by a clamping device 5.

FIG. 4. refers to the top view of an impression tray 8. with it's handle 7. being inserted into the attachment 5. of the dental vibrating device 10.

FIG. 5 refers to a side view of an impression tray 8 with it's handle 7. being inserted into the dental vibrating device 10. The plate 4. helps to guide the insertion of the tray handle 7. and facilitates it's attachment to the dental vibrating device 10. by the attachment clamp 5.

FIG. 6. refers to a side view of an impression tray 9. with it's handle 7 fully inserted into the vibrator attachment 5. The dental vibrating device 10., begins to vibrate as the operator's finger 18. presses down on the switch 3. as the tray 9. is seated over the teeth and/or gums. As soon as the impression tray 9. which is filled with impression material (not shown) is in place over the teeth and/or gums, the operator's finger may slide off the switch onto the tray or other part of the vibrator case or housing 11. thereby stopping the vibration and allowing the impression material (not shown) inside the tray to harden or set undisturbed.

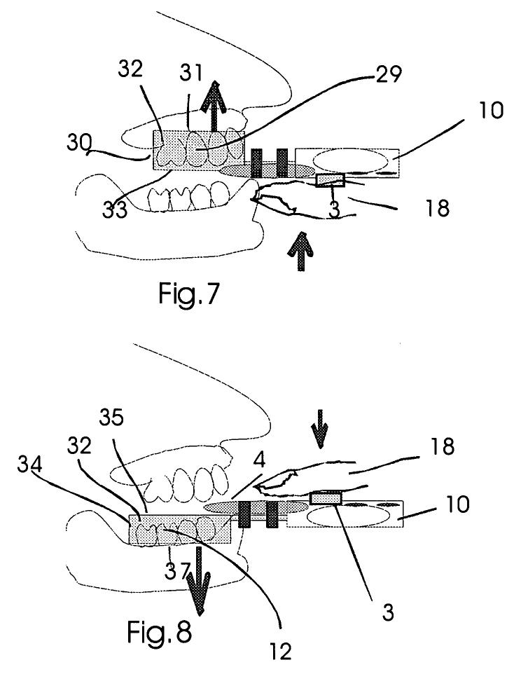

FIG. 7. refers to dental vibrating device 10. attached to a maxillary dental impression tray 30. being inserted into the mouth over the maxillary teeth 29. The dental vibrating device 10. attaches to the impression tray 30. so that the switch 3. is opposite to the open side 31. of the impression tray. (the side of the impression tray into which the impression material is inserted. A plate extension 4. engages the closed side 33. of the maxillary impression tray 30. efficiently transmitting vibration to the impression material 32, contained therein over the maxillary teeth 29. with a positive and secure seating pressure.

FIG. 8. refers to a dental vibrating device 10 attached to a mandibular dental impression tray 34. being inserted into the mouth over the mandibular teeth 12. The dental vibrating device 10 attached to the impression tray 34. so that the switch 3. is positioned opposite to the open side 37 of the mandibular impression tray 34 (the side into which the impression material is inserted. The plate extension 4. engages the closed side 35.of the mandibular impression tray 34 efficiently transmitting vibration to the impression material 32 contained therein over the mandibular 12. teeth.

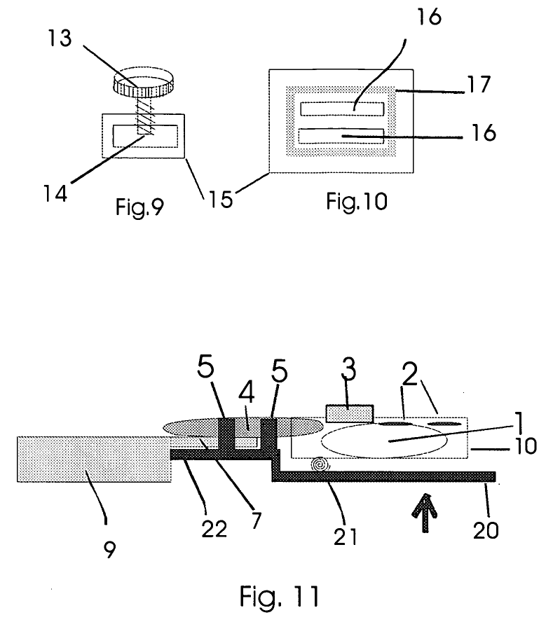

FIG. 9. refers to an embodiment of the present invention which is a horizontal cross section of the clamp 15. which holds the handle of an impression tray. A screw 13. type of clamp can be turned clockwise to wedge the end of the screw shank 14 on the tray handle and thereby secure said tray handle to the dental vibrating device. The screw 13 is then turned counterclockwise to open and thereby loosen the clamping effect of the screw shank 14 on the tray handle and allowing easy withdrawal of the impression tray from the dental vibrating device 10.

FIG. 10. Refers to a preferred embodiment of the present invention which is a clamp consisting of upper and lower plates 16. being held tightly together with a heavy duty rubber band or bands 17. The handle of the impression tray (not shown) can be inserted in between the plates 16. and held securely and then withdrawn following the impression taking.

FIG. 11. Refers to a preferred embodiment of the present invention consisting of a lever 20 which rotates around a fulcrum 21 and attaches to an arm 22 which is held by a an attaching device 5 which may consist of but not limited to a elastic or elastic bands 5. As the lever 20 is squeezed by the operator's thumb and forefinger (not shown), the clamp 22 is opened and the impression tray handle is inserted between the lever arm 22. and the vibrator arm 4. and the lever 20. is released thereby attaching and securely fixing the tray handle 7. to the dental vibrating device 10. The lever 20 is squeezed again to release the tray handle from the clamping device.

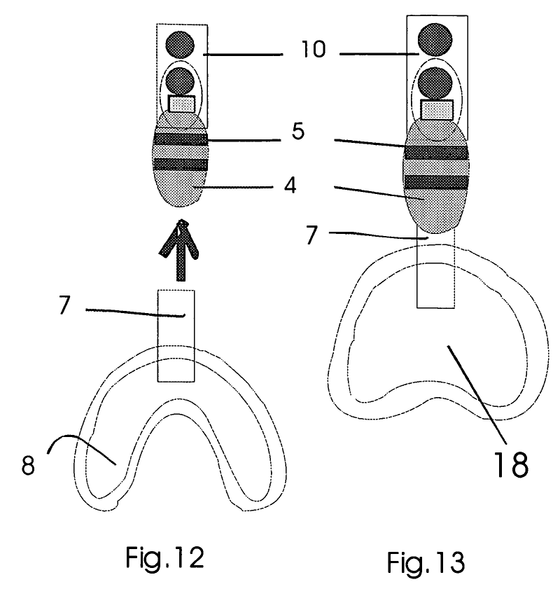

FIG. 12. Refers to an embodiment of the present invention consisting of a handle 7. of a mandibular impression tray 8. being inserted into the attachment device 5. of the dental vibrating device 10.

FIG. 13. Refers to a full maxillary impression tray 30. inserted into the attaching device 4. of the dental vibrating device 10.

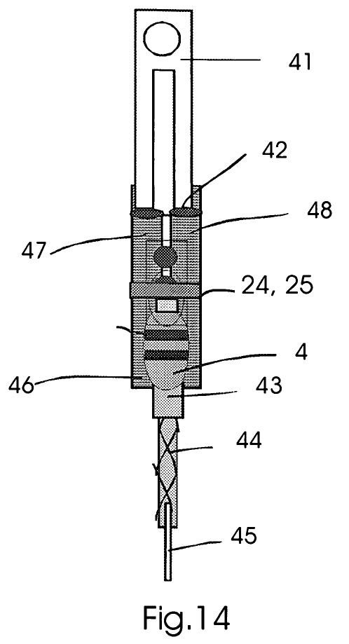

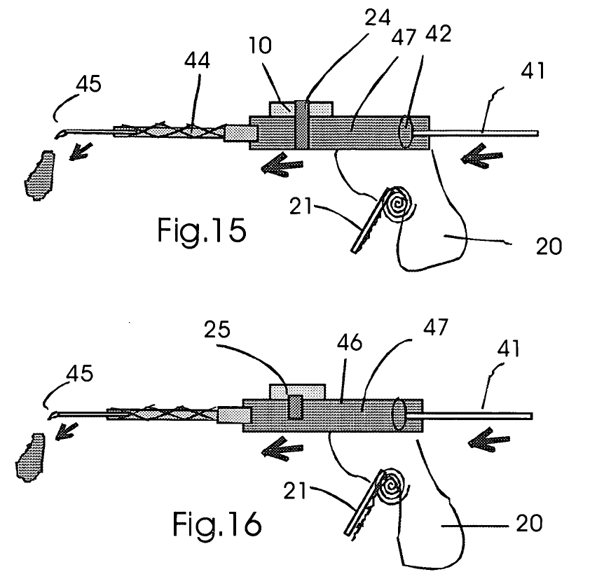

FIG. 14 refers to a top view of a longitudinal cross section of a cartridge and gun type apparatus commonly used in dentistry to hold and dispense impression material. The dental vibrating device 10. is firmly attached 24.,25. to the impression cartridge 46. containing a tube of the base impression material 47. and a tube of the catalyst impression material 48. in a position as close to the mixing nozzle 44. as possible so that as much vibration as possible is transmitted through said mixing nozzle 44. and ejection tip as possible. The vibrating device lever 4. helps to further secure the dental vibrating device 10. to the impression cartridge 46 and also helps to transmit vibration closer to the mixing chamber 44. and ejection tip 45. The plunger assembly 41. is activated when the operator squeezes the trigger 21 (FIG. 15), and the plungers 42. compress the base 47 and the catalyst 48 through the connecting chamber 43. which connects the mixing nozzle 44. with the impression cartridge 46.

FIG. 15 is a side view of a longitudinal cross section of a cartridge and gun type apparatus commonly used in dentistry to hold and dispense impression material with the vibrating dental device attached to said apparatus with an elastic type attachment 24. The dental vibrating device 10. is firmly attached to the impression cartridge 46. containing a tube of the base impression material 47. and a tube of the catalyst impression material 48. in a position as close to the mixing nozzle 44. as possible so that as much vibration as possible is transmitted through said mixing nozzle 44. and ejection tip 45. as possible. The vibrating device lever 4. helps to further secure the the dental vibrating device 10. to the impression cartridge 46 and also helps to transmit vibration closer to the mixing chamber 44. and ejection tip 45. The plunger assembly 41. is activated when the operator holds the impression container gun handle 20. and squeezes the trigger 21. and the plungers 42. compress the base 47 and the catalyst 48 through the connecting chamber 43. which connects the mixing nozzle 44. with the impression cartridge 46. and expels the mixed impression material (a mix of base and catalyst) through the tip 45. around the teeth and gums. (not shown).

FIG. 16 a horizontal cross section of a cartridge and gun type apparatus commonly used in dentistry to hold and dispense impression material with the vibrating dental device attached to said apparatus with a friction lock or clip type attachment. 25.

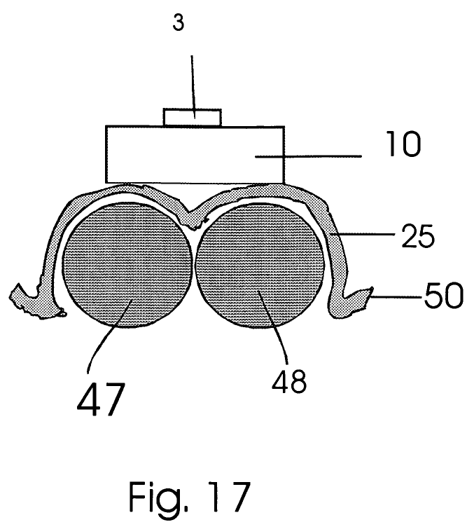

FIG. 17. refers to the flexibly rigid friction lock attachment device 25. which engages the undercut of the circular tubes of base 47 and catalyst 48 of the impression cartridge container 46. thereby attaching said container 46. securely to the dental vibrating device 10. Flange extensions 50. of the friction lock attachment 25. allow for easy attachment and disengagement from the undercut of the cartridge 46. allowing for easy and rapid removal of the dental vibrating device from the cartridge 46.

1. A vibrating device which attaches to containers which hold, or contain materials used in dentistry.

2. A vibrating device as recited in claim 1, which attaches to tubes which hold, or contain materials used in dentistry.

3. A vibrating device as recited in claim 1, which attaches to trays which hold, or contain materials used in dentistry.

4. A vibrating device as recited in any one of claims 1 and 2, which dispense materials used in dentistry.

5. A vibrating device as recited in any one of claims 1 to 4 which attaches to tubes or trays or other containers which hold, or contain or dispense materials used in dentistry with an attachment which is clamp-like in nature.

6. A vibrating device as recited in any one of claims 1 to 4 which attaches to tubes or trays or other containers which hold, or contain or dispense materials used in dentistry with an attachment which is clamp-like in nature said clamp attaches the device to the or trays or other containers which hold, or contain or dispense materials used in dentistry with a clamp which is rigidly flexible and fabricated to engage and grip said dental container so as to hold and friction lock said container to the vibrating device.

7. A vibrating device as recited in any one of claims 1 to 4 which attaches to tubes or trays or other containers which hold, or contain or dispense materials used in dentistry with an attachment which is clamp-like in nature said clamp attaches the device to the or trays or other containers which hold, or contain or dispense materials used in dentistry with a clamp consisting of an upper and lower bar or plate which is spring loaded and which said springs applies pressure on said bars or plates engaging the said dental material container, and said spring is connected to a lever which can be regulated by pressure exerted by a finger or thumb.

8. A vibrating device as recited in any one of claims 1 to 4 which attaches to tubes or trays or other containers which hold, or contain or dispense materials used in dentistry with an attachment which is clamp-like in nature said clamp attaches the device to the or trays or other containers which hold, or contain or dispense materials used in dentistry with an elastic rubber band engaging the said dental material container.

9. A vibrating device as recited in any one of claims 1 to 4 which attaches to tubes or trays or other containers which hold, or contain or dispense materials used in dentistry with an attachment which is clamp-like in nature said clamp attaches the device to the or trays or other containers which hold, or contain or dispense materials used in dentistry with a clamp consisting of an upper and lower bar or plate which is enveloped or surrounded by an elastic rubber band which applies pressure on said bars or plates engaging the said dental material container.

10. A vibrating device as recited in any one of claims 1 to 4 which attaches to tubes or trays or other containers which hold, or contain or dispense materials used in dentistry, and which imparts to or transmits such vibration to said materials used in dentistry.

11. A vibrating device as recited in any one of claims 1 to 4 which attaches to tubes or trays or other containers which hold, or contain or dispense materials used in dentistry, wherein said material consists essentially of one selected from the group consisting of, but not limited to, polyvinylsiloxane, silicone, polyether, rubber base, alginates, plaster, pastes, gel, restorative materials, composite restorative materials, cements, glass ionomer or modified glass ionomers, and which imparts to or transmits such vibration to said materials used in dentistry.

12. A vibrating device as recited in any one of claims 1 to 4 wherein the vibrator is powered by a battery or batteries.

13. A device as recited in any one of claims 1 to 4 wherein the vibrations of the vibrator is continuous or intermittent or variable.

14. A method of extruding or dispensing dental materials from a container with vibration as recited in any one of claims 1 to 4 by attaching a vibrating mechanism to the dental material container and transmitting said vibration to the dental or impression material.

15. A method of taking an impression of a natural or prepared tooth or teeth, ready to accept a dental prosthesis or restoration, comprising but not limited to the steps of:
(A) Attaching a vibrating device to the dental or impression tray as recited in any one of claims 1-4.
(B) Attaching a vibrating device to the dental or impression dispenser as recited in any one of claims 1, 2, 4.
(C) Turning the vibrating device on, and extruding the unset impression material from said impression container through the mixing tube.
(D) While vibrating, placing the mixed unset impression material into a tray or other container. Placing said tray or other container around the tooth or teeth, (natural or prepared abutment(s)) or gums using vibration imparted to the mixed unhardened or unset impression material from the vibrator attached to the tray or container.
(E) Stop vibration after the impression tray or dental container is placed completely over the tooth or teeth, (natural or prepared abutment(s)) or gums. Wait until the impression material hardens and/or sets.
(F) Start vibration and then withdraw impression tray or container easily and atraumatically from teeth and gums

16. A method of taking an impression of a natural or prepared tooth or teeth, ready to accept a dental prosthesis or restoration, comprising but not limited to the steps of:
(G) Attaching a vibrating device to the dental or impression tray as recited in any one of claims 1-4.
(H) Attaching a vibrating device to any one of a dental, dental tube, or impression dispenser. As recited in any one of claims 1, 2, or 4. containing a heavy bodied impression material.
(I) Attaching a second vibrating device to the second dental or impression dispenser as recited in any one of claims 1, 2, 4. containing a lighter bodied impression material.
(J) As recited in 19 (H), While the vibrator attached to the impression tube, or syringe or container is turned on, extruding or placing the unset heavy bodied impression material through the mixing tube into a tray or other container as recited in any one of claims 1-4.
(K) Turning the second vibrating device on, and extruding the mixed unset lighter bodied impression material from the container of the second impression dispenser through the mixing tube and while vibrating, placing the mixed unset lighter bodied impression material from this second tube into the sulcus around the prepared tooth abutment.
(L) Placing said tray (16 G) or other container around the tooth or teeth, (natural or prepared abutment(s)) or gums using vibration imparted to the mixed unhardened or unset heavy bodied impression material from the vibrator attached to the tray or container.
(M) Stop vibration after the impression tray or dental container is placed completely over the tooth or teeth, (natural or prepared abutment(s)) or gums. Wait until the impression material hardens and/or sets.
(N) Start vibration and then withdraw impression tray or container easily and atraumatically from teeth and gums.

17. A method of taking an impression of a natural or prepared tooth or teeth, ready to accept a dental prosthesis or restoration, comprising the steps of:
(A) Attaching a dental or impression tray to the dental vibrating device as recited in any one of claims 1-5.
(B) (OPTIONAL STEP) Attaching a dental vibrating device to the impression tube, syringe or container or container holding the impression material as recited in any one of claims 1, 2, 4.
(C) (OPTIONAL STEP) Turning on the vibrator as the unset impression material is being extruded and mixed in cartridge nozzle.
(D) Placing the mixed unset impression material into a tray or other container as recited in any one of claims 1 to 5.
(E) Placing said tray or other container around the tooth or teeth, (natural or prepared abutment(s)) or gums using vibration imparted to the unhardened or unset impression material from the vibrator attached to the tray or container.
(F) Stop vibration after the impression tray or dental container is placed completely over the tooth or teeth, (natural or prepared abutment(s)) or gums. Wait until the impression material hardens and/or sets.
(G) Start vibration and then withdraw impression tray or container easily and atraumatically from teeth and gums.

18. A method of taking an impression of a natural or prepared tooth or teeth, ready to accept a dental prosthesis or restoration, comprising the steps of:
(A) Attaching a dental or impression tray to the dental vibrating device as recited in any one of claims 1-5.
(B) (OPTIONAL STEP) Attaching a dental vibrating device to the (#1) impression tube, syringe or container or container holding the impression material as recited in any one of claims 1, 2, 4.
(C) (OPTIONAL STEP) Turning on the vibrator as the unset heavier body or firmer setting impression material is being extruded and mixed in cartridge nozzle.
(D) Placing the mixed unset heavier body or firmer impression material into a tray or other container as recited in any one of claims 1 to 5.
(E) Placing said tray or other container around the tooth or teeth, (natural or prepared abutment(s)) or gums using vibration imparted to the unhardened or unset impression material from the vibrator attached to the tray or container.
(F) Stopping vibration after the impression tray or dental container is placed completely over the tooth or teeth, (natural or prepared abutment(s)) or gums. Wait until the impression material hardens and/or sets.
(G) Start vibration and then withdraw impression tray or container easily and atraumatically from teeth and gums.
(H) Remove undercuts from set impression (with scalpel blade or bur or other means)
(I) (OPTIONAL STEP) Turning on the vibrator attached to impression tube or container (#2) as lighter bodied or more fluid unset impression material is being extruded and mixed in cartridge nozzle.
(J) Place lighter bodied or more fluid unset impression material into tray of heavier bodied set impression.
(K) Replacing said tray filled with lighter bodied unset impression material lying in cavity of set heavier bodied impression material over the tooth or teeth, (natural or prepared abutment(s)) or gums using vibration imparted to the unhardened or unset lighter bodied impression material from the vibrator attached to the tray or container.
(L) Stopping vibration after the impression tray or dental container is placed completely over the tooth or teeth, (natural or prepared abutment(s)) or gums. Wait until the impression material hardens and/or sets.
(M) Start vibration and then withdraw impression tray or container easily and atraumatically from teeth and gums.

19. A method of taking an impression of a natural or prepared tooth or teeth, ready to accept a dental prosthesis or restoration, comprising but not limited to the steps of:
(N) Attaching a dental or impression tray to the dental vibrating device as recited in any one of claims 1-5.
(O) (OPTIONAL STEP) Attaching a dental vibrating device to the (#1) impression tube syringe or container or container holding the impression material as recited in any one of claims 1, 2, 4.
(P) (OPTIONAL STEP) Turning on the vibrator as the unset heavier body or firmer setting impression material is being extruded and mixed in cartridge nozzle.
(Q) Placing the mixed unset heavier body or firmer impression material into a tray or other container as recited in any one of claims 1 to 5.
(R) Placing said tray or other container around the tooth or teeth, (natural or prepared abutment(s)) or gums using vibration imparted to the unhardened or unset impression material from the vibrator attached to the tray or container.
(S) Stopping vibration after the impression tray or dental container is placed completely over the tooth or teeth, (natural or prepared abutment(s)) or gums. Wait until the impression material hardens and/or sets.
(T) Start vibration and then withdraw impression tray or container easily and atraumatically from teeth and gums.
(U) Remove undercuts from set impression (with scalpel blade or bur or other means)
(V) (OPTIONAL STEP) Turning on the vibrator of impression container (#2) as lighter bodied or more fluid unset impression material is being extruded and mixed in cartridge nozzle.
(W) Place lighter bodied or more fluid unset impression material into heavier bodied set impression.
(X) Place lighter bodied or more fluid unset impression material into sulcus of prepared tooth abutment(s).
(Y) Replacing said tray filled with lighter bodied unset impression material lying in cavity of set heavier bodied impression material over the tooth or teeth, (natural or prepared abutment(s)) or gums using vibration imparted to the unhardened or unset lighter bodied impression material from the vibrator attached to the tray or container.
(Z) Stopping vibration after the impression tray or dental container is placed completely over the tooth or teeth, (natural or prepared abutment(s)) or gums. Wait until the impression material hardens and/or sets.
(AA) Start vibration and then withdraw impression tray or container easily and atraumatically from teeth and gums.

20. A method of taking an impression of a natural or prepared tooth or teeth, ready to accept a dental prosthesis or restoration, comprising but not limited to the steps of:
(BB) Attaching a dental or impression tray to the dental vibrating device as recited in any one of claims 1-5.
(CC) (OPTIONAL STEP) Attaching a dental vibrating device to the (#1) impression tube syringe or container or container holding the impression material as recited in any one of claims 1, 2, 4.
(DD) (OPTIONAL STEP) Turning on the vibrator as the unset heavier body or firmer setting impression material is being extruded and mixed in cartridge nozzle.
(EE) Placing the mixed unset heavier body or firmer impression material into a tray or other container as recited in any one of claims 1 to 5.
(FF) Placing said tray or other container around the tooth or teeth, (natural or prepared abutment(s)) or gums using vibration imparted to the unhardened or unset impression material from the vibrator attached to the tray or container.
(GG) Stopping vibration after the impression tray or dental container is placed completely over the tooth or teeth, (natural or prepared abutment(s)) or gums. Wait until the impression material hardens and/or sets.
(HH) Start vibration and then withdraw impression tray or container easily and atraumatically from teeth and gums.
(II) Remove undercuts from set impression (with scalpel blade or bur or other means)
(JJ) (OPTIONAL STEP) Turning on the vibrator of impression container (#2) as medium bodied unset impression material is being extruded and mixed in cartridge nozzle.
(KK) Place medium bodied impression material into heavier bodied set impression.
(LL) (OPTIONAL STEP) Turning on the vibrator of impression container (#3) as light bodied unset impression material is being extruded and mixed in cartridge nozzle.
(MM) Place lighter bodied or more fluid unset impression material into sulcus of prepared tooth abutment(s).
(NN) Replacing said tray filled with medium bodied unset impression material lying in cavity of set heavier bodied impression material over the tooth or teeth, (natural or prepared abutment(s))or gums using vibration imparted to the unhardened or unset medium and lighter bodied impression material from the vibrator attached to the tray or container.
(OO) Stopping vibration after the impression tray or dental container is placed completely over the tooth or teeth, (natural or prepared abutment(s)) or gums. Wait until the impression material hardens and/or sets.
(PP) Start vibration and then withdraw impression tray or container easily and atraumatically from teeth and gums.
